(19) United States
(12) Patent Application Publication
(10) Pub. No.: US 2026/0267342 A1
(43) Pub. Date: Sep. 10, 2026

(54) FLIGHT TRAJECTORY PLANNING SYSTEM FOR DRONES IN CHARGE OF FIRE MANAGEMENT IN OPEN ENVIRONMENTS

(71) Applicant: ROPAT TECHNOLOGIES SRL, Bolzano (IT)

(72) Inventor: Robert Niederkofler, Bolzano (IT)

(73) Assignee: ROPAT TECHNOLOGIES SRL, Bolzano (IT)

(21) Appl. No.: 19/165,986

(22) PCT Filed: Mar. 22, 2023
(86) PCT No.: PCT/IB2023/052794

§ 371 Date: Sep. 16, 2025

(51) Int. Cl. G05D 1/617; G05D 1/248; G05D 1/69; G05D 105/55; G05D 107/30; G05D 109/20; G05D 111/10; G05D 111/30; G05D 111/50

(52) U.S. Cl. CPC G05D 1/619; G05D 1/248; G05D 1/69; G05D 2105/55; G05D 2107/36; G05D 2109/20; G05D 2111/14; G05D 2111/32; G05D 2111/56

(57) ABSTRACT

The present invention finds its application, in general, in the field of fire prevention. In particular, the identified solution pertains to the problem of the early detection of the beginnings of a fire that could develop in large, open environments, such as, more precisely, woods and forests. The invention indicates a system for determining a flight path for a heat-resistant drone, allowing it to be used in missions in which it is pushed to the limit of its heat-resistant characteristics. This is made possible by using an environmental simulation tool that allows for the precise assessment of the risk of damage to the heat-resistant drone while it is on a mission.

### RELATED APPLICATIONS

This patent application is based on the Italian patent application n. IT 102021000030197, filed on 1 Dec. 2021, of which it constitutes an improvement.

### BACKGROUND OF THE INVENTION

### 1. Field of the Invention

The present invention finds its application, in general, in the field of fire prevention.

In particular, the identified solution pertains to the problem of identifying and managing outbreaks or fires that could develop in large, open environments, such as, more precisely, woods and forests.

The early detection of the beginnings of fire is the most effective measure for the containment and extinguishing of fires that develop in forests. In fact, the sooner a fire is identified, the smaller it is; and therefore, the greater the possibilities of taming it, or extinguishing it, or at least of contain its evolution, thus avoiding environmental catastrophes.

Therefore, every solution that improves the detection and characterization of a fire is a solution that improves fire prevention in general. For this reason, we should never stop researching and developing solutions capable of increasing the speed of detection of a fire, as well as the precision with which this fire is characterized, so as to adopt the best measures to intervene in order to extinguish it.

### 2. Brief Description of the Prior Art

The problem of fires in vast wooded areas is a very serious and topical problem; it is also a problem whose incidence, in recent years, has been significantly increasing in the world, and of which the perception of public opinion is also well aware.

Various causes combine to determine this growing severity. In fact, it can definitely be said that the existing forest heritage is already very small from the outset, due to the widespread anthropization of many territories and, as if this were not enough, it is destined to further decrease due to the ongoing climate change.

In particular, the greater frequency and duration of drought periods in some territories, in addition to triggering slow desertification processes, precisely during the hottest and driest periods, makes the woods more easily inflammable, due to the low humidity retained by the wooded environments in such periods.

Even the significant incidence of arsonable fires is a cause that is perceived as very serious, especially since it also seems to be subject to a dynamic of growth.

Ultimately, it can be said that the risk of forest fires is now officially considered, by many nations, to be a real emergency, and even of a serious level.

So far, in terms of prevention, the response to this problem has mainly focused on educational measures. At various levels of communication, an attempt has been made to make people who frequent the woods aware not to adopt risky behaviors. This action is certainly effective for all the people who frequent woods, and natural areas in general, with a spirit of interest and respect for nature, and who care about its protection, but it is much less so for another part of the population with less environmental sensitivity, to the point of being totally ineffective towards the people who are responsible for the triggering of arson.

Once the fire develops, then, the measures envisaged for extinguishing are extremely complex, requiring the use of many means and many men.

The use of airplanes or helicopters capable of pouring water on the fire, as well as other substances that reduce the flammability of the plants, would make it possible to intervene effectively if the interventions could be implemented when the fire is not yet too extensive; but unfortunately, often, these interventions cannot be put into practice with the necessary timeliness, as the means that perform this service (the most common are the aircraft produced by the Canadian company Canadair) are very expensive and their number is limited, so that they often have to arrive from places far from the fire, further increasing the intervention delay. So, it is frequent that forest fires turn into a real environmental catastrophe within a few days.

In some cases then, the wind and the climatic conditions in general, for example in circumstances where the climate has been dry for several days, cause fires in wooded areas to develop very quickly; and when their dimensions become too large it becomes very difficult to contain them with interventions by firefighters (however numerous and equipped they are) or with the use of airplanes or helicopters that throw water from above: in many cases, when the woods are sufficiently close to the coasts, it is salt water taken directly from the sea. In these cases, the fires last for several days and destroy tens or hundreds of thousands of plants, as well as compromising the regrowth of plants for decades when extinguishing is resorted to by spreading salty sea water.

The only way to contain the seriousness of the situation linked to forest fires is to detect their onset earlier.

Unfortunately, however, the extension of the wooded areas makes any type of punctual and detailed monitoring particularly difficult. The decision to tackle the problem by deploying massive monitoring infrastructures therefore seems inevitable; in fact, it is unthinkable to monitor a vast area such as those that characterize the woods, without an adequate infrastructural supervision, since there is normally no network of paths that allow to inspect woods and forests in any other way.

One way, which appears to be promising, consists in the creation of a certain number of monitoring stations suitably equipped in order to support the continuous surveillance of a fairly extensive area around this station: an order of magnitude of the distance up to which this type of monitoring stations can extend their surveillance is several kilometers. This order of magnitude of the distance must obviously be understood as a purely illustrative data and can vary, even greatly, according to the individual cases (for example according to the orography of the territory) and according to the technologies used in the station itself.

However, this approach is not yet widespread due to its costs; in fact, these monitoring stations require energy supplies, the presence of equipped personnel, and much more.

There are some projects, at the moment they are at stage of proposal, or limited to demonstration installations, wherein it is envisaged:
the construction of a tower or trellis structure, which allows to obtain a high observation point; it typically also acts as a telecommunication station to manage the interaction among all the sensors and systems present in the monitoring infrastructure as a whole, as well as the communication with other control stations;
the distribution, in the forest, of a network of sensors of various types, suitable for transmitting to the observation station data correlated to the presence or risk of fire;
the use of a fleet of drones with various specializations, and suitable for performing specific tasks, being able to move to reach various points in the supervised forest.

In general, while it isn't possible to monitor a large area of several square kilometers with a high detail, then the surveillance must be set up by providing for different levels of detail.

Therefore, an initial wide-ranging surveillance must be envisaged, capable of identifying situations of fire probability; while, more detailed inspection levels must be able to be activated only after having selected specific, and possibly very delimited, areas on which focus a detailed monitoring.

For the purposes of the present invention, it is assumed that, through monitoring stations of the indicated type, a large-scale surveillance is implemented, able to warn in real time situations of fire risk, or fire suspicion, and, following these warnings, it is triggered the problem of activating punctual surveillance measures, or initial measures to contain the possible start of fire, with interventions on site.

It is clear that innumerable configurations of surveillance stations are possible with different costs and performances, in which the technological endowments are more or less abundant and different as regards the quality of their performances.

Furthermore, in addition to the elements mentioned above (observation tower, network of sensors and fleet of drones), which constitute an equipment that can be considered basic for many proposed solutions, the monitoring stations can also include plants and systems of other types, especially to support any interventions for the containment of the fires detected; for example: basins with water reserves, cisterns with substances useful for the treatment of fires, equipment for equipping rescue teams, energy generation systems for the needs of the station itself, and all the systems that refer to it, and more.

Consequently, the variety of equipment that can be comprised in such stations generates an almost indefinable variety of possible different configurations for them.

In the context of the present description, we do not go into the huge variety of configurations that can be conceived to define the tasks and objectives of the monitoring stations; rather, we focus on a particular problem which, depending on how it is solved, can positively or negatively affect the performance of a monitoring station as a whole, in a significant number of different configurations. The addressed problem is that of reaching as quickly as possible, and as close as possible, with a drone, the points where a fire is developing.

Speed is of the essence, because the size, and therefore potential unmanageability, of a fire often increases very rapidly.

Proximity is also very important in order to acquire precise information (in the case of drones with observation tasks), but also to be able to implement targeted containment measures in the points where these can be truly effective.

A trivial example, but useful for exposing the above concepts, is that of a drone carrying containers of extinguishing substances to be thrown over a fire to put it out, or to be thrown along the front of a fire to stop its expansion.

These containers have the size of a few decimeters and, when they are dropped onto a still small fire, extending a few meters, they spread their contents and are often able to put out a small fire.

If, on the other hand, they are to be launched for the purpose of creating an incombustible zone to stop the advance of an expanding fire front, they must create a continuous belt, without parts with combustible material which would allow the fire front to advance by piercing the front of containment.

Even imagining that a drone can transport a certain number of such extinguishing containers, it is clear that to be effective, this drone must arrive on site before the extension is too large. Furthermore, in order for the intervention to be effective, the containers must be dropped with good precision, so as to cover the entire foreseen surface, to prevent from resisting an outbreak that could eventually extend, making the extinguishing attempt vain. It is clear that if the containers were dropped from above, at a certain distance, the landing accuracy may not be sufficient. Consequently, the launch drone in the example, in addition to having to arrive early, must be able to fly very close to the fire, in environmental contexts with temperatures at the limit of its resistance specifications.

Once the flames are extinguished or contained, it often happens that after a few hours, even at night, small outbreaks are reborn. This problem is widespread, and it is for this reason that it is necessary to monitor the territory, closely and continuously, extending a careful monitoring even when the fire is apparently extinguished, in order to intervene quickly to nip in the bud any revitalization of the flames.

All the above observations make it clear that the use of drones is a key factor both for ensuring good monitoring and for implementing the first early interventions. Furthermore, it is clear that the number of drones available at each monitoring station is also a critical factor for the effectiveness of both monitoring and intervention. It is clear that with a few drones it is not possible to monitor large areas of forest with good frequency and closely enough (to identify even small outbreaks). Similarly, few drones cannot dispense sufficient quantities of extinguishing substances to contain the development of a fire. If we add to this the fact that many actions in charge of drones are based on very specialized functions, it can be concluded that the fleet of drones that a monitoring station must have at its disposal should be extremely numerous (the more numerous the fleet of drones is, the more a monitoring station can be effective in fire prevention and management).

One way to try to contain the number of drones, without accepting too penalizing compromises, with respect to the effectiveness of both monitoring and intervention, consists in having drones capable of performing a plurality of functions. The latter approach (i.e., resorting to universal drones capable of performing various functions in a specialized way) is certainly viable in theory; in practice, it involves numerous technical difficulties which considerably limit its potential. Many of these challenges relate to the fact that different functions require different physical performance; for example, some functions require speed, others require the ability to fly in very high temperature environments, other functions require carrying capacity, and so on.

If it is intended to implement a monitoring system for large extensions of woods and forests, the prior art certainly provides various technologies. The technologies described above, in fact, are available and can be used both to carry out a fairly effective monitoring and to implement actions to fight fires, or, at least, to assist in the implementation of actions against fires.

The state of the art, at system level, for the application identified in the present patent is well represented by US 2012/0261144 A1 [“FIRE MANAGEMENT SYSTEM”—Vian, J.L. (US), Saad E.W. (US), on behalf of BOEING—Oct. 18, 2012].

This document describes a very complex system, which makes use of numerous technologies to create a real fire-fighting system for woods and forests.

The system proposed in US 2012/0261144 A1 comprises flying and land vehicles, with pilot and autonomous driving, various sensors (both video sensors and other types) which allow to detect the presence of fires, a control tower, equipped with suitable calculation means, which allows the implementation of appropriate coordination and control functions for the interventions that are necessary to prevent and counter the development of fires, and it takes into account the environmental conditions to predict the development of any fires.

The problem of systems such as the one proposed in US 2012/0261144 A1 can be traced back, in a nutshell, to the possible complications of using unlimited means which consequently raise questions of high costs. In fact, it is quite intuitive to state that, being able to have unlimited resources, it is possible to deal with fire threats at a theoretical level, but without the guarantee of success for the many problems encountered in forests. However, given that the availability of unlimited means and their efficiency in any situation is a purely theoretical hypothesis, it is evidently necessary to accept a compromise in which a limitation of means is assumed, and the risk of not being able to manage all the fires is accepted, without prejudice to the achievement of an optimal intervention efficiency.

Regardless of the verification of the optimal efficiency of the system, the compromise indicated in US 2012/0261144 A1 is still too unbalanced on costs that are too high, so much so that more than ten years after the BOEING proposal, fire management systems such as the one indicated in US 2012/0261144 A1 are not widespread at all, despite the fact that the phenomenon of forest fires is perceived as a problem of growing importance, considered absolutely urgent and whose solution is now unavoidable.

Another solution, which worth mentioning, is the one disclosed in US 2019/176987 A1—“System and Method for fire suppression via Artificial Intelligence”-Beecham J.E. [US] et al.—Ser. No. 13/06/2019. This document, in fact, is cited since it represents another significant example of the state of the art, wherein a system based on drones' technology is used for fire-fight management.

To make these solutions feasible, it is therefore necessary to invent as many devices as possible that introduce strong optimizations, under penalty of the practical impossibility of proposing such systems for the management of fires in woods and forests.

### SUMMARY OF THE INVENTION

The main purpose of the present invention consists in pursuing strong optimizations in the use of drones, which, as seen, are essential tools both in the monitoring phase and in the early intervention phase in the event of a fire.

Therefore, the invention aims to indicate a flight control system for multifunctional drones to be used in a fire monitoring station; and this control must ensure that the flight path is optimized with respect to the function assigned to each drone, taking into account the fact that:
each drone has a heat resistance that can be defined in terms of the maximum temperature of the environment in which it can fly, and in terms of time in which this drone can withstand certain temperatures,
each drone offers certain performances in terms of minimum and maximum flight speed and in terms of the maximum load it can carry,
each drone has a certain flight range as a function of the flight speed and the load carried.

Of particular interest are the flight trajectories that allow a specific drone to reach areas affected by the risk of a developing fire as quickly as possible and as close as possible to the fire itself, remaining there for the time necessary to carry out its mission, and return without being damaged.

In fact, the effectiveness of the mission depends a lot on the precision with which the drones can carry out the task assigned to them, and to do this they must get as close as possible to the fire.

The technical problem associated with achieving this goal is further exacerbated by the fact that, for reasons of resource optimization (essential for being able to realistically propose such systems), it is necessary to resort to the use of multifunction drones, i.e., drones that can be assigned to different tasks, depending on the case.

The optimization of the flight path must be able to be updated in real time even when the drone is already in flight, as the environmental conditions can change quickly, or because the environmental information can also be updated later than when the drone must take off to reach the fire in good time.

As already mentioned, the optimization must also take into account the task assigned to the drone, in order to avoid missions in which the risks of drone damage are not justified by the results that the mission can bring, or, on the contrary, it can be chosen to sacrifice a drone, for example by accepting that it burns during the mission, provided that it manages to carry out a very important task before its destruction.

It is assumed that all the hypotheses put forward, and all the projects proposed, for monitoring stations for forest fires cannot disregard the fact that they are significantly computerized stations. In fact, their operation depends on their ability to acquire and interpret data flowing to these stations. Among these data, climatic and environmental data are obviously very relevant, and therefore it will be assumed that climatic and environmental data are available, and that these data can be processed with adequate, very powerful, and state-of-the-art computing means.

The objectives indicated can be achieved through a flight trajectory planning system of a plurality of multifunctional drones, each of which can be equipped with at least two different payloads; and this flight trajectory planning system is equipped with calculation means, configured to determine safe flight routes, and with devices supplied to each drone belonging to said plurality of multifunctional drones, which are each associated with its own information sheet which specifies:
the maximum resistance time of the drone itself at various temperatures, with its different payloads, that is how long said drone can operate correctly when it is operating at high temperatures;
the minimum and maximum flight speeds according to the payload with which it is equipped;
the flight range, i.e., the energy or fuel consumption according to the payload with which it is equipped; and among said devices supplied to each drone belonging to said plurality of multifunctional drones are included (among other things):
a) bidirectional radio communication means between said multifunctional mission drone and at least a fixed radio station;
b) two-way radio communication means between each multifunctional drone and another multifunctional drone (wherein said means of communication indicated in points “a)” and “b)” may coincide);
c) at least one temperature sensor or a thermal imager.
d) memory means suitable for memorizing at least one flight path;
e) geolocation means suitable for detecting the position and the instantaneous speed of the drone itself, in order to verify, while it is in flight, and albeit in an approximate way, whether the flight path it is making is compliant, or not, with said at least one memorized flight path;
and said system for determining safe flight trajectories for multifunctional drones also comprises an environmental model which represents, in computer format, the physical environment which contains the flight trajectories planned for said plurality of multifunctional drones.

All the characteristics listed above, although not widespread in the systems actually implemented, are substantially known art. What characterizes the invention is the possibility of exploiting the environmental model in a particularly efficient way, significantly improving the precision with which the model itself can predict the real environmental conditions in which the drone must fly.

Therefore, the drone flight path planning system, in the case of missions that require getting as close as possible to the fire, is characterized by the fact that it also includes a second observation drone equipped with temperature sensors, a thermal imaging camera and sensors for acquiring wind speed and direction.

Ultimately, on closer inspection, the drone flight trajectories planning system according to the invention is in fact configured to simultaneously control the flight of pairs of drones: a first mission drone which flies near the fire, and a second observation drone with reliable data acquisition functions, able to determine the boundary conditions to effectively use the aforementioned environmental model.

The route of said second observation drone is planned to bring the drone to the area where the fire is present, but without getting as close to it as possible, so as to always be at safe temperatures, with essentially zero risk of being damaged by fire.

The drone flight trajectories planning system according to the invention is therefore also characterized in that it comprises suitable calculation means also arranged to determine said safe flight trajectories for said mission drone by processing said trajectories through their simulation within an environmental model, in turn characterized by the fact that:
the temperature values of all the points of said physical represented environment are updated, substantially in real time, and
said environmental model is suitable for simulating the evolution of said temperature values in the near future in the event of a fire that develops in said physical environment, and
said simulations are carried out by means of a simulation program, executed by means of said calculation means, and configured to process some input data among which there are at least the following data:
temperature data, also detected by said thermal imaging camera with which said second observation drone is equipped, and which is positioned at safe height with respect to a possible fire,
data about speed and direction of wind, detected by special sensors with which said second observation drone is equipped;
data describing the vegetation which is present in said environment represented by said environmental model, in which said data descriptive of the vegetation comprise a parameter which expresses the combustibility of the described vegetation.

This processing of said input data, together with other information including data detected directly by the mission drone itself, allows to evaluate, essentially in real time (the real-time approximation obviously depends on the involved computing power), the evolution of a fire, and consequently the temperatures in the space in which each multifunctional drone is flying (obviously when it is on a mission) according to the route it is following.

This therefore makes it possible to recalculate and update, substantially in real time, the best trajectory to follow, possibly also modifying the intervention strategy to be adopted, to adapt it to the evolution of the situation.

The main advantage compared to known systems (although not implemented in real applications, for the reasons explained above) consists in the greater precision with which the environmental model allows to foresee the evolution of the environmental situation; in fact, no planning system provides for the simultaneous planning of the routes of a pair of drones, one of which (the observation drone) follows a safe route that is simpler to plan as it does not have to go too close to the fire, and that is essentially dedicated to collecting very precise and significant measurements. The measurements collected by said second observation drone, in fact, are really precise and significant precisely because they were collected near the route followed by the other drone (i.e., the drone that must carry out the mission near the fire), which must fly in an environment that must be known as much as possible.

It is observed, and underlined, that the characterizing part of the flight planning system for a drone on a mission near a fire, according to the teachings of the invention, benefits from the presence of an additional drone, and concerns some functional characteristics present in various elements of a more complex system set up to prevent and contain the development of devastating fires in woods and forests.

The system involves the construction of a certain number of monitoring stations scattered in the forest area to be monitored. This system, comprising monitoring stations which also act as a support and control station for a fleet of drones, can be designed according to innumerable variants but, in order to comply with the teachings of the present invention, it must obviously comprise at least a pair of drones with the characteristics previously indicated, and computing means suitable for keeping updated an environmental model, able to describe the evolution of the temperature field in a given area, even when affected by a fire.

The invention makes it possible to calculate flight trajectories in such a way that a drone with known heat resistance characteristics can enter areas where there are very high temperatures, but ensuring that the permanence of the drone in these areas remains within the limits in which the drone is able to resist or, in any case, to operate according to an operational program which is established as the one necessary to manage a specific case of fire.

In this way, the main requirement for which the invention was conceived is satisfied, because the proposed solution introduces an important optimization of the overall system, as the compromise between costs and benefits introduced by the fire prevention system is substantially improved.

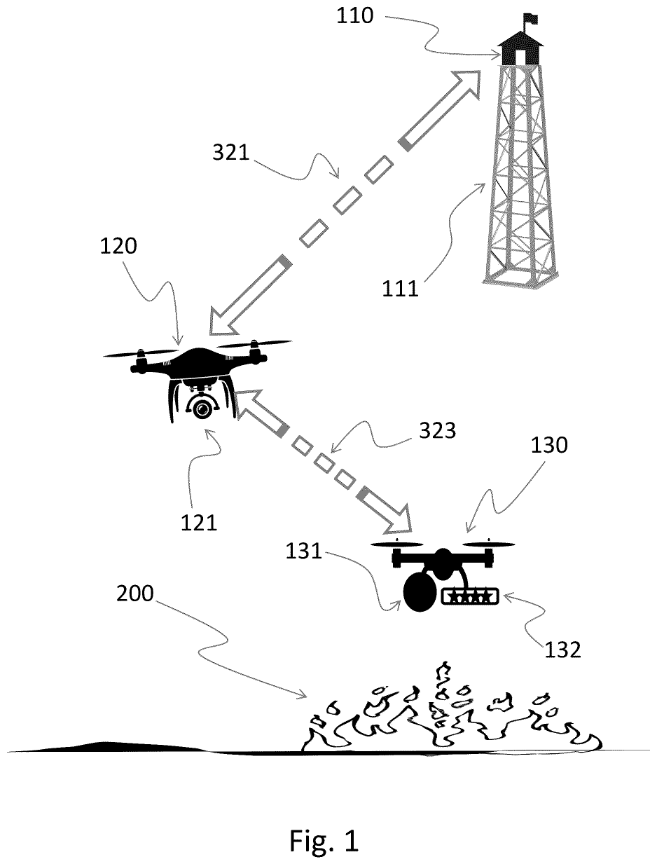

This invention also has further advantages, which will become more evident from the following description, from some examples of practical embodiments which illustrate further details, from the attached claims which form an integral part of the present description, and from the attached FIG. 1 which shows a simplified overview of the teachings of the invention in an implementation context.

### BRIEF DESCRIPTION OF THE DRAWINGS

In FIG. 1 a context of application of the teachings of the invention is shown in broad terms: in the figure, one can visually appreciate some (not all) of the numerous innovative devices that can be used to implement the invention.

In particular, FIG. 1 shows a fire that is spreading at a certain distance from an observation station, located in an elevated position. Said fire, in the generic case, takes place at such a distance that it is not possible to observe it in detail from the observation station, from which, typically, it is only possible to identify some signs that can arouse the suspicion that there is a fire threat.

Therefore, the observation, to be effective, must make use of suitable means to approach the fire, and to find detailed information: and according to the teachings of the invention it is envisaged that a drone is sent on a mission, to carry out in-depth observations taken close to the fire itself.

The teachings of the invention foresee that the mission involves two drones:
a drone referred to as “mission drone”, because it is equipped to perform functions that require it to get as close as possible to the fire, entering areas with potentially very high temperatures,
and a drone referred to as “observation drone”, equipped with instrumentation suitable for detecting data to define the boundary conditions to be used in the simulations, which are necessary to provide for the calculation of the safest flight trajectory for the “mission drone”.

### DETAILED DESCRIPTION OF THE PREFERRED EMBODIMENTS

The flight planning system of a drone which has to carry out a mission near a fire, realized according to the teachings of the present invention, makes use of some known technologies which allow to obtain general performances of interest.

A first technology that can be accessed, critical to implementing this invention, is the drone technology. The offer of these vehicles is extremely lively and in constant evolution, given that they are objects that can be used for a very large number of applications. In particular, there are several drones which are more or less heat-resistant, with extremely interesting characteristics, that allow to reach points at even quite high temperatures, as there are thermo-protective treatments that allow you to protect generic drones in order to be able to use them at higher temperatures than those for which they are initially designed. Such solutions are certainly interesting for realizing some embodiments of the present invention.

In any case, regardless of the heat resistance characteristics, each drone can theoretically be managed by planning its flight according to the teachings of the present invention so as to make it fly safely even in environments characterized by potentially dangerous temperature conditions. What is important, for the purposes of implementing the invention, is that it is possible to characterize with sufficient accuracy the maximum temperatures at which the considered drone can work, also specifying the maximum times for which it can remain exposed to these temperatures.

Applications involving missions in dangerous environments for humans are some of the typical applications for which drone technology is designed. Therefore, it is no surprise that there are drones designed to operate in high temperature environments; in these cases, these drones are normally supplied with specific technical data sheets which indicate exactly the heat resistance limits, within which their operation is guaranteed.

Such heat resistant drones can evidently be used to implement the teachings of the present invention.

The invention, however, can also be implemented with drones designed for generic applications, possibly treated with suitable paints or thermo-protective substances, or equipped with a heat-resistant coat effective in heat protection.

Obviously, in addition to drones for generic applications, these protective measures can also be adopted on drones specifically designed for applications in fire contexts, so further improving the heat-resistance characteristics of the latter.

As an example, and in support of the statement that it is possible to improve the thermo-resistance performance of any drone, a substance produced by the American “GelTech Solutions” based in Florida which provides some thermo-protective substances, is mentioned (see also https://geltechsolutions.com/fireice/product/fireice-561/), including an extremely effective gel that can be sprinkled on the external surfaces of a drone, preserving it for a certain time from excessive heating, even if hit directly by a flame.

Other interesting solutions to protect generic drones to be used in flight missions in high temperature contexts are offered by the Italian company “Flame Spray” (see also https://www. flamespray.org/it/tecnologie/cold-spray/), also specialized in the supply of substances and materials to protect objects of any kind from excessive overheating.

Ultimately, it can be concluded that the known art offers various solutions for realizing heat-resistant drones, suitable for the implementation of the present invention.

It is clear that, if generic drones are used, which are subsequently treated to increase their heat resistance performance, it is necessary to provide a characterization of the performance obtained through such treatments. If this characterization is not easily inferable from the technical sheets of the products used, it is always possible to arrive at a characterization suitable for the implementation of the invention through a measurement procedure carried out experimentally.

In fact, if the heat-resistance is an important feature to be able to plan flight missions that penetrate deeply into an area affected by a fire, from a strictly functional point of view, to implement the invention, what is binding is the availability of a quantitative characterization of the real heat-resistance performances.

Another important known technology which can be conveniently used in the implementations of the present invention is given by the environmental simulation techniques.

In fact, there are very reliable meteorological forecast models, which work in mesoscale, and which can be configured on even very small spatial definitions, so as to be able to represent very accurately the fields of temperature, pressure and speed of the air, in the three-dimensional space where a drone plans to fly.

An example of a simulation tool of this type is known by the acronym WRF (Weather Research and Forecasting), which is also an “open source” tool. The WRF model requires input of initial and boundary information of a meteorological type (such as wind, temperature, humidity and geopotential), and through simulations, whose spatial and temporal definition is configurable, it produces meteorological values within a three-dimensional space, and in particular in the space where it is intended to send a heat-resistant drone on a mission.

There are also numerous simulation models of the development of fires capable of predicting the evolution of a fire starting from meteorological and environmental data. The meteorological data can be those produced by a meteorological model (such as the WRF model), while other environmental data describe the environment in which the fire develops, and include information on the vegetative state of the plants and their predisposition to burn.

The combination of the two models, i.e., the meteorological model and the fire development model, makes it possible to determine with excellent approximation the temperature, pressure and air speed fields in the space in which drones engaged in fire management must fly.

It should be noted that the WRF meteorological model is designed to work in conjunction with the fire evolution simulation program called “Fire”, giving rise to an integrated “WRF-Fire” tool which is particularly accurate because it takes into account in an extremely precise way also the effect of the fire on the meteorological data, given that the development of a fire obviously has effects on the temperature and on the generation of air currents of a thermal nature.

Ultimately, it can be stated that, starting from boundary information at an initial instant, it is theoretically and practically possible to reconstruct an accurate description of the temperature fields concerning the space in which a heat-resistant drone is envisaged to enter to complete a mission associated with fire management. Furthermore, the accuracy of the simulation program, if performed with very strict definitions (something limited only by the available calculation powers), also allows to estimate the thermal currents that are generated in the space affected by a fire.

It is clear that the accuracy of these models significantly depends on the accuracy of the input data, the boundary conditions and the size of the space in which the most precise characterization is to be obtained: and it is precisely with reference to these latter aspects that the invention offers an essential and decisive contribution to the practical applicability of these models.

In fact, without data relating to the boundary conditions, which refer to a space very close to the points where the simulation is to be accurate, the simulation technology does not offer the performance that is necessary, in order to obtain an efficient applicability in real cases.

Many research environments use and develop the “WRF-Fire” tools which, to date, are considered the most complete software for this kind of simulations.

Furthermore, being “open source” software tools, they lend themselves to continuous evolution, updates, and adaptations to the most varied applications.

Therefore, the simulation tools based on the “WRF-Fire” technologies, and on their evolutions (for which the acronym WRF-SFIRE, i.e., Spread Fire, is also frequently used), appear, at the moment, the preferred tool for realizing the model of environmental simulation necessary for the implementation of the present invention.

For more information on WRF-Fire/WRF-SFIRE technology, please refer to the official website of the organization (see https://wiki.openwfm.org/wiki/WRF-Fire). Finally, it can be concluded that the simulation tools necessary for the implementation of the invention can be considered known tools, but since they are tools for very specialized use, they are usable just by figures with a high degree of specialization.

Therefore, given the degree of specialization that is necessary to use these simulation tools, all the application possibilities of these modeling tools have not yet been explored and, in particular, there are no state-of-the-art applications aimed at planning a flight path of a drone.

In order to complete a sufficient feasibility analysis of the invention, it is necessary to mention other technologies capable of detecting the other essential data to implement the flight planning system of a heat-resistant drone according to the teachings of the invention: in particular suitable technologies are necessary to find the aforementioned meteorological data, as well as the data on the vegetative state of the plants which are present in the area affected by a fire (or by a start or threat of fire).

The solution indicated in the present invention involves associating the mission of the heat-resistant drone, i.e., the actual mission drone (of which the system calculates the optimal flight route with respect to pre-set objectives), a support mission conducted through a second drone, called observation drone. This second observation drone is equipped to detect essential data so that the route of the heat-resistant mission drone (which performs the most important and active part of the fire management mission) can be better planned. In particular, said observation drone provides and completes the information on the boundary conditions, which are necessary to use any mesoscale meteorological model, and collects data on the vegetative state of the plants affected by the spread of the fire.

The route of this observation drone is designed to fly it close to the fire, but not inside the fire area, i.e., in safe conditions, and typically at an optimal altitude to observe from above (then, not from inside) the evolution of a fire. In fact, this observation drone is substantially positioned on the edge of the three-dimensional space that must be simulated, i.e., in an ideal position for measuring the boundary data that all simulation models need to be able to implement reliable simulations.

Furthermore, using suitable thermal imaging cameras, said observation drone is suitable for detecting a map of temperatures on the ground, or, the temperature of the external surfaces of the vegetation that can be seen from above, so as to offer the model further information to refine its simulations.

Finally, again with sensors mounted on these observation drones, it is possible to detect some characteristics on the vegetative state of the plants and their degree of dryness.

This information on the vegetative state can also be acquired using known technologies based on spectral analyzes carried out with active sensors which irradiate the underlying vegetation with radiation at various wavelengths and measure the intensity of the reflected radiation. We do not go into these technologies for determining the vegetative state of plants here, however it should be noted that these technologies are available, as their development and fine-tuning are conducted above all for applications in mechanized agriculture, in which the automatic detection of the state of a plantation is essential for calibrating the treatments to be provided to the plants or, more simply, for regulating irrigation in an optimal way.

By combining the data collected by sensors (which can present significant variability over time, even in the short term) with maps expressing the type of vegetation present in a forest (which, on the other hand, are rather stable information over time) it is certainly possible to keep an updated map in which each point of the forest is assigned with flammability index, expressive of the real flammability of the forest point by point.

Consequently, an appropriate combined environmental model, such as those mentioned above, can very well simulate the spread of flames, in any contingent circumstance.

It should be noted that these maps, expressing the type of vegetation, evidently do not need to be detected in real time as they represent relatively stable information; they can therefore be considered as available information, and they can be pre-established maps kept updated through mapping processes regularly performed, even with fairly slow detection rates, and outside the missions activated in reaction to the occurrence of a fire risk (for example a map of the plants present in a wood, updated a few days before a mission, it is certainly a reliable map, certainly usable in the context of such a mission).

Finally, it should not be forgotten that the invention makes sense if it is possible to quickly identify the areas at risk of triggering a fire, or the areas in which a fire principle is developing.

Obviously, this preliminary analysis is decisive in fire prevention and, the better it is conducted, the more it is possible to exploit the teachings of the present invention in the optimal way.

These are analyzes which today can be conducted in many ways, and at various levels of inspection: starting from observation processes conducted from elevated positions on the top of the tower of the observation station, as foreseen in the preferred implementation of the present invention, or continuing with observations made at high altitudes by special drones, up to analyzes based on data coming from possible sensors scattered in the woods, and without neglecting the possibilities offered by analysis techniques based on artificial intelligence, above all to predict any malicious behavior by people who can be identified semi-automatically and in various ways.

This part of analysis is not the object of the present invention. For the purposes of this description, it suffices to state that it is possible to implement analysis strategies, based on the collection of data that make it possible to select areas of a forest in which it is advisable to plan the mission of a heat-resistant drone for carrying out suitable tasks of fire prevention or early containment.

The flight trajectory planning system of a drone, used in missions that require it to get as close as possible to a fire, is therefore a very articulated system that provides for the cooperation of a plurality of technologies which, although at the state of the art, are very advanced and must be integrated in an innovative way.

Flight route planning may seem like just a detail compared to the complexity of managing fires that flare up in woods and forests, however it is a very important detail from a qualitative point of view, which allows you to optimize interventions by being able to apply an optimal management of individual cases, on the basis of very accurate information and also being able to carry out physical interventions on the fire, in a targeted and surgical way.

In FIG. 1 a context of application of the teachings of the invention is shown in broad terms: in the figure, one can visually appreciate some (not all) of the numerous innovative devices that can be used to implement the invention.

In FIG. 1, the number 200 shows a fire that is spreading at a certain distance from an observation station, indicated with the number 110, and located in an elevated position, being positioned on top of a tower indicated with the number 111.

Said fire 200, in the generic case, takes place at such a distance that it is not possible to observe it in detail from the observation station 110, from which, typically, it is only possible to identify some signs that can arouse the suspicion that there is a fire threat. Therefore, the observation, to be effective, must make use of suitable means to approach the fire 200, and to find detailed information: and according to the teachings of the invention it is envisaged that a drone is sent on a mission, to carry out in-depth observations taken close to the fire itself. The teachings of the invention foresee that the mission involves two drones: potentially two drones of the same type but equipped with different equipment.

The drone indicated in FIG. 1 with the number 130 is referred to as mission drone, because it is equipped to perform functions that require it to get as close as possible to the fire, entering areas with potentially very high temperatures.

Said mission drone 130 is characterized in that its thermal resistance characteristics must be known, i.e., the maximum temperatures at which it can operate, and the times for which it can keep operating in the areas at these maximum temperatures without being damaged. Said mission drone 130 is the drone whose optimal trajectory must be calculated, to bring it as close as possible to the flames of the fire 200. Generally, these mission drones are equipped with various instruments, which can be classified into two types.
The number 131 indicates tools suitable for carrying out physical interventions on the fire 200: typically, these tools are dispensers of substances with extinguishing properties.
The number 132, on the other hand, indicates survey instruments. Among these tools, the following are worth mentioning: cameras capable of acquiring detailed images, to document particular parts of the fire (or of the start of the fire), and environmental sensors to measure temperatures, pressures and any air currents.

Said mission 130 drone must also be able to acquire its own position, in order to verify if it is following the planned trajectory, as well as to geo-reference the acquired surveys.

In some the preferred embodiments, said mission drone 130 is set up with arrangements which increase its heat-resistance properties (ranging from the use of particular coats to the application of suitable paints designed for the purpose, and which have been mentioned in the first part of this description).

As already mentioned, several times, the definition of the trajectory followed by the mission drone 130 must be calculated with the maximum possible precision, in order to exploit the drone to the limit of its performance, and this calculation makes use of the model which describes by simulation the field of temperatures of the environment in which the drone is immersed. The simulation requires measured boundary data, and further continuous measurements for feedback and verification, in order to refine the simulated values, given that the evolution of fires is often very rapid.

The problem of guaranteeing the availability of such boundary information, as well as feedback information on the simulation results, is solved by providing that this mission is also accompanied by a second drone equipped for the purpose: this second drone is referred to as observation drone, and it is indicated in FIG. 1 with the number 120. The observation drone 120 is therefore equipped with instrumentation suitable for detecting data to define the boundary conditions to be used in the simulations, and to make other observations useful for verifying, and possibly correcting, the values calculated by simulation.

Said observation drone 120, as mentioned, comprises an arsenal of environmental sensors and cameras, including also a thermal camera sensitive to infrared radiation. In FIG. 1, the number 121 indicates a “payload”, with which the drone 120 must be equipped when used as an observation drone. In particular, the “payload” 121 of the drone 120 is generally different from the “payload” of the mission drone 130. In fact, the observation drone 120 does not need devices for dispensing extinguishing substances or even observation devices suited to operate at very high temperatures; instead it must be equipped to collect, with the best possible reliability, all the boundary data that serve as input to the environmental simulation model, so that this can generate reliable forecast data, regarding the precise evolution of temperatures in the environment that is the theater of the mission ; in this equipment, sensors dedicated to measuring the speed and direction of air currents cannot be missing, given that this data is fundamental in all environmental models.

FIG. 1 also shows how said drones, for observation (120) and mission (130), are connected by suitable communication channels. The communication network to which the two drones are connected is necessary to implement the invention, but it can be based on different architectures, which give rise to many variants of the invention. FIG. 1, however, highlights two links that can represent an essential and efficient setup.

The mission drone 130, which have to fly in very critical environments, must be equipped with systems that are as simple and light as possible, therefore it maintains a local and short-range connection only with the observation drone 120, this connection being indicated in FIG. 1 with the number 323.

Said connection 323 is the simplest possible, and the shortest possible, given that the observation drone 120 travels relatively close to the heat-resistant drone 130, with the only foresight not to enter the hottest areas of the fire.

Communication with the observation station 110, that actually acts as a real control station too, is instead ensured by the radio connection, indicated in FIG. 1 with the number 321, which keeps the observation drone 120 connected directly to the observation station 110.

The fact that the mission drones are always connected to the control station 110 (directly or indirectly) is an important feature of the invention, since the critical route of the heat-resistant mission drone 130 must be constantly monitored, and possibly corrected according to the observations acquired and according to the evolution of the fire.

Well, the fact that the teachings of the invention provide that critical missions are conducted with a pair of drones allows, among other things, to ensure absolutely reliable radio communications even in critical conditions, communications which, in turn, being reliable, allow to exploit considerable computing powers that can be allocated in the control station 110, just equipping the drones with minimal computing means, sufficient to control their operational functionality, their equipment, and the transmission of the data acquired to the control station.

More complex processing, synthesizing the collected data, does not need to be performed on board of the drone, given that the instructions for carrying out the various missions can be reliably transmitted to the mission drone 130, even when it is in the flames of a fire.

### Concluding Remarks

Ultimately, the system for determining flight paths of a heat-resistant drone, according to the present invention, compared to the traditional solutions proposed by the prior art, offers teachings which bring about improvements in the early management of forest fires. In fact, it can be assumed that the invention defines a category of monitoring systems capable of characterizing and treating principles of fires that arise in open environments, this category of systems being characterized by the availability of drones 130 which can be made heat-resistant and equipped to carry out very “reckless” missions, at the limit of their resistance capacity, in extreme environmental contexts, such as the environments that are generated during fires.

The teachings of the invention can be applied to a large variety of approaches to the problem of forest fire containment, but all of these approaches, if they implement these teachings, can achieve better performance and results than those achievable today using only the known technique.

The peculiarity of the invention consists in the planning of controlled flight routes which involves pairs of drones, which divide their tasks efficiently, and which allow the forecasting models to operate with reliable data.

Since the applicability of the invention is so varied, the invention itself lends itself to innumerable variations, being able to exploit different types of drones, as well as drones with different tasks. However, it is essential to be able to use drones, i.e., one of the most important assets of the fire management system, in the most flexible way possible, in order to be able to optimize their use in all possible situations. So that the invention, in its preferred embodiments, provides for the use of a fleet of drones substantially of the same type, but configurable to perform different functions, equipping them from time to time with different “payloads”.

Other variants may also concern the optimal flight trajectory that the planning system provides to the mission drones 130, which can respond to various optimization criteria, what matters is that the system that calculates this optimal trajectory can have information that allow the 130 heat-resistant mission drones to approach the limit of their possibilities, with sufficient assurance that the assigned task can be successfully completed.

The use of the plural, speaking of mission drones 130, also indicates another possible application variant, which consists in planning intervention missions involving a plurality of heat-resistant mission drones 130 (also with different “Payloads” and with different tasks) who cooperate in a single mission, and which can be configured to act according to the situation they find: therefore, their tasks can undergo modifications and adaptations during the mission itself. And all the mission drones acting on the same place can benefit from the data collected by a single observation drone 120. In this case, each single mission drone 130 is still coupled to an observation drone 120, even if the latter, in turn it can also be coupled to another mission drone operating in the same area.

Still other variants may concern the functions for which the various drones can be prepared. By way of example, an additional function, but there may obviously be many others, could be that of emitting an acoustic signal for the benefit of any people involved within an area affected by the fire, so as to provide them with a help to save themselves.

Furthermore, the invention itself can be implemented in an essential way as outlined in the present description with the aid of FIG. 1, or it can be enriched with further useful features.

For example, both the observation drone 120 and the heat-resistant mission drone 130 can have a much richer sensory apparatus than the one mentioned, in which, in addition to the temperature sensor, other sensors are present. Among the sensors that certainly appear very interesting for the application considered, especially in the heat-resistant drone 130, we mention sensors suitable for detecting the pressure, or data on the composition of the air, or on the presence of turbulence and any air currents, especially those that are generally created in the vicinity of a fire.

Some of this data, in addition to trajectory planning, can also be useful for conducting real-time planning of the tasks to be assigned to the heat-resistant mission drones 130, while they are already on a mission.

The availability of a fleet with many drones is also justified because often (especially in arson fires) several sites are simultaneously affected by an outbreak.

In these cases, if it is not possible to intervene on all outbreaks simultaneously, it is necessary to make a choice of priority sites that can be defined using a predictive calculation model that promptly identifies the site where the effect of the fire is most dangerous. If, for example, five sites distant from each other are attacked by fire at the same time, they will have different developments of the outbreak, and the model, through a fire evolution simulation, will choose the site where the fire will develop faster, for example by taking into account of the wind speed at the various sites.

Even the telecommunications equipment can be suitable for establishing a plurality of connections with different entities, ranging from fixed stations set up in the woods, to the central observation station, up to the setup of direct connections with other means involved in fire management, such as other drones or emergency vehicles of various types, or with operating stations of the personnel who are working, even in the field, to contain the fire.

Furthermore, especially if in the future the approach of developing an infrastructure for managing forest fires becomes a widespread approach, it is foreseeable that new technologies will become available to create increasingly specialized sensors for this application, and therefore both drones and the any network of sensors disseminated in the monitored forest will be able to enrich the information to be processed to feed both the environmental model and the optimal trajectory calculation program, thus providing for further improvements associated with the present invention.

Therefore, especially in the context of the expected evolutionary scenarios, the invention lends itself to incorporating and supporting further development and improvement efforts, capable of improving the performance of the described system. It follows that many further developments could be made by a man skilled in the art without thereby departing from the scope of the invention as it results from the present description and from the claims attached hereto which form an integral part of the present description; or, if said developments are not included in the present description, these may be the subject of further patent applications associated with the present invention, or dependent on it.

1. A System for determining safe flight trajectories for a mission drone (130), which presents the following prerogatives:
said mission drone (130) is associated with an information sheet,
and said information sheet specifies:
the maximum resistance time of the drone itself at various temperatures, that is how long said drone can operate correctly when it is operating at high temperatures,
the minimum and maximum flight speeds according to the payload with which it is equipped,
the flight range, i.e., the energy or fuel consumption according to the payload with which it is equipped;
and said mission drone (130) also includes:
bidirectional radio communication means between said mission drone (130) and at least a second radio station;
at least one temperature sensor;
memory means suitable for memorizing at least one flight path;
geolocation means suitable for detecting the position and the instantaneous speed of the mission drone (130) itself, in order to verify,
while it is in flight, and albeit in an approximate way, whether the flight path it is making is compliant, or not, with said at least one memorized flight path;
and said system for determining safe flight trajectories for a mission drone (130) is characterized by the fact that it also comprises:
A. a second observation drone (120) equipped with temperature sensors, a thermal imaging camera and sensors for the acquisition of speed and direction of wind,
B. computing means also designed to determine said safe flight routes for said mission drone (130),
C. an environmental model that represents, in computer format, the physical environment that contains the flight paths determined for said mission drone, being said environmental model characterized in that:
a. the temperature values of all the points of said represented physical environment are updated, substantially in real time,
b. it is configured for simulating the evolution of temperatures in the near future in the event of a fire that develops in said physical environment,
c. said simulations are performed through a simulation program, executed by means of said computing means, and configured to process some input data including at least:
i. temperature data, also detected by said thermal imaging camera with which said second observation drone (120) is equipped, and which is positioned at safe height with respect to a possible fire,
ii. data about speed and direction of wind, detected by special sensors (121) with which said second observation drone (120) is equipped,
iii. data describing the vegetation which is present in said environment represented by said environmental model, in which said data descriptive of the vegetation comprise a parameter which expresses the combustibility of the described vegetation.

2. The system for determining safe flight trajectories for a mission drone (130), according to claim 1, wherein said mission drone (130) is a heat-resistant drone, being equipped with a heat-resistant coat, or treated with protective heat-resistant paints.

3. The system for determining safe flight trajectories for a mission drone (130), according to claim 1, in which said at least one memorized flight path, is calculated and updated, substantially in real time, as a function of the evolution of temperatures, according to values calculated by means of simulations carried out with said environmental model.

4. The system for determining safe flight trajectories for a mission drone (130), according to claim 1, which comprises at least one monitoring station (110) located in an elevated fixed position, wherein said observation drone (120) is equipped for maintain a direct radio connection (321) with said at least one monitoring station (110).

5. The system for determining safe flight trajectories for a mission drone (130), according to claim 1, wherein said second at least one radio station with which said heat-resistant drone (130) is enabled to communicate is located in said observation drone (120).

6. The system for determining safe flight trajectories for a mission drone (130), according to claim 1, wherein said mission drone (130) is also equipped with dispensers of substances with extinguishing properties.

7. The system for determining safe flight trajectories for a mission drone (130), according to claim 1, wherein said mission drone (130) is also equipped with a video-camera.

8. The system for determining safe flight trajectories for a mission drone (130), according to claim 1, wherein said mission drone (130) is also equipped with one or more environmental sensors to measure any air currents.

9. The system for determining safe flight trajectories for a mission drone (130), according to claim 1, wherein said mission drone (130) is also equipped with one or more environmental sensors to detect information on the composition of air.

10. The system for determining safe flight trajectories for a mission drone (130), according to claim 1, wherein said environmental model is suitable for simulating the evolution of temperatures in the near future in the event of a fire, and it is made in “WRF-Fire” technology.
